(19) United States
(12) Patent Application Publication
(10) Pub. No.: US 2025/0385521 A1
(43) Pub. Date: Dec. 18, 2025

(54) IMPROVED PEAK MICROGRID LOAD DISPATCH

(71) Applicant: Caterpillar Inc., Peoria, IL (US)

(72) Inventors: Sowmya NAGESH, Peoria, IL (US); Ronald Christopher GAYLES, Peoria, IL (US); Gregory Scott HASLER, Pekin, IL (US); Ranjay SINGH, Kanpur (IN); Manoj Kumar BANTUPALLI, Vizianagaram (IN)

(73) Assignee: Caterpillar Inc., Peoria, IL (US)

(21) Appl. No.: 18/745,482

(22) Filed: Jun. 17, 2024

(51) Int. Cl. H02J 3/32; H02J 3/38; H02J 7/00

(52) U.S. Cl. CPC H02J 3/32; H02J 3/388; H02J 7/0048; H02J 7/00712; H02J 2203/10

(57) ABSTRACT

A microgrid controller of a microgrid includes a communication interface configured to receive load information corresponding to a current load demand of a plurality of loads connected to the microgrid and output control signals for controlling energy resource systems associated with the microgrid, which include a non-stabilizing group and a stabilizing group; and one or more processors, coupled to the one or more memories, configured to execute a load stabilization algorithm to generate the one or more control signals based on the load information. Executing the load stabilization algorithm includes generating, based on the load information, one or more first control signals to dynamically control an amount of total output power provided by the stabilizing group to a power distribution network of the microgrid in order to stabilize one or more cyclic loads on the power distribution network and to maintain the non-stabilizing group at a substantially constant load.

### TECHNICAL FIELD

The present disclosure relates generally to microgrids and, for example, to a microgrid controller configured to control or manage an operation of a microgrid.

### BACKGROUND

A microgrid is a self-sufficient energy system that serves a particular geographic area, such as a college campus, a hospital complex, a business center, a neighborhood, a mining site, a drilling site, and/or the like. Within a microgrid are one or more kinds of distributed energy resources (DERs) (e.g., solar panels, wind turbines, fuel cells, photovoltaic (PV) cells, generators, energy storage devices (e.g., batteries, capacitors, etc.), and/or other energy sources) that produce power for the microgrid. Some microgrids are configured as off-grid electrical power distribution systems (e.g., stand-alone microgrids or islands) that do not connect to a larger electrical power distribution system (e.g., a macrogrid) run by, for example, an electric utility or power plant. Some microgrids are able to operate in a grid-connected mode and in a stand-alone mode. In a grid-connected mode, a microgrid may operate connected to and synchronous with the larger electrical power distribution system. In a stand-alone mode, the microgrid may be disconnected from the larger electrical power distribution system and operate as a stand-alone microgrid. A microgrid controller may control whether the microgrid operates in the grid-connected mode or in the stand-alone mode, for example, based on a schedule or based on one or more conditions being satisfied.

A recurrence of frequency deviations on a microgrid may be caused by repetitive load steps produced by one or more non-stable loads, such as one or more cyclic loads. For example, cyclic loads may be produced at mine sites or oil rigs where crushers or industrial drills may be used over short bursts of time. A total load increases on a microgrid when non-stable loads come online periodically. The increase in the total load causes a frequency deviation on the microgrid from a nominal value, and a power quality provided by the microgrid is reduced.

CN U.S. Pat. No. 10,984,2140B (“the ′140B patent”) discloses an intelligent control method of peak-valley load balance of a high-tension distribution network. In the ′140B patent, an intelligent peak-value load balance management subsystem of a low-tension transformer area is used for primary peak adjustment in the balancing process, secondary peak adjustment is carried out by the distribution network itself, energy storage compensation and photovoltaic compensation are used to clip the peak and fill the valley in the balancing process, the supply side determines the quantity of running generator sets to the power supply load demand of each transformer area and the power supply load of the power grid, the number of running sets during the peak is reduced, the power supply cost is reduced, peak adjusting fluctuation of the transformer area is limited within +/−5%, approximately linear power output is realized, the power generating set is prevented from idle running, and equipment of the generating set is kept safe.

The microgrid controller of the present disclosure solves one or more of the problems set forth above and/or other problems in the art. For example, the microgrid controller may execute a load stabilization algorithm to control one or more energy resource systems associated with a microgrid in order to stabilize one or more cyclic loads connected to the microgrid to provide load smoothing.

### SUMMARY

In some implementations, a microgrid controller of a microgrid includes one or more memories configured to store a load stabilization algorithm; a communication interface configured to receive load information corresponding to a plurality of loads connected to the microgrid and output one or more control signals for controlling a plurality of energy resource systems associated with the microgrid, wherein the plurality of energy resource systems includes a non-stabilizing group of energy resource systems and a stabilizing group of energy resource systems; and one or more processors, coupled to the one or more memories, configured to execute the load stabilization algorithm to generate the one or more control signals based on the load information, wherein executing the load stabilization algorithm comprises: calculating a total load of the plurality of loads based on the load information, calculating a first target load for the non-stabilizing group of energy resource systems and a second target load for the stabilizing group of energy resource systems, wherein a sum of the first target load and the second target load is equal to the total load, measuring a state-of-charge (SOC) of the stabilizing group of energy resource systems, calculating a bias power to maintain the SOC of the stabilizing group of energy resource systems within a target range, calculating a first total output power for the non-stabilizing group of energy resource systems based on the first target load and the bias power, calculating a second total output power for the stabilizing group of energy resource systems based on the second target load and the bias power, generating, based on the first total output power, one or more first control signals to control an operation of the non-stabilizing group of energy resource systems to produce the first total output power, and generating, based on the second total output power, one or more second control signals to control an operation of the stabilizing group of energy resource systems to produce the second total output power.

In some implementations, a microgrid controller of a microgrid includes one or more memories configured to store a load stabilization algorithm; a communication interface configured to receive load information corresponding to a current load demand of a plurality of loads connected to the microgrid and output one or more control signals for controlling a plurality of energy resource systems associated with the microgrid, wherein the plurality of energy resource systems includes a non-stabilizing group of energy resource systems and a stabilizing group of energy resource systems; and one or more processors, coupled to the one or more memories, configured to execute the load stabilization algorithm to generate the one or more control signals based on the load information, wherein executing the load stabilization algorithm comprises: generating, based on the load information, one or more first control signals to dynamically control an amount of total output power provided by the stabilizing group of energy resource systems to a power distribution network of the microgrid in order to stabilize one or more cyclic loads on the power distribution network and to maintain the non-stabilizing group of energy resource systems at a substantially constant load.

In some implementations, a control method includes receiving, by a microgrid controller of a microgrid, load information corresponding to a current load demand of a plurality of loads connected to the microgrid; and controlling, by the microgrid controller, a plurality of energy resource systems associated with the microgrid, wherein the plurality of energy resource systems includes a non-stabilizing group of energy resource systems and a stabilizing group of energy resource systems, wherein controlling the plurality of energy resource systems includes: generating, based on the load information, one or more control signals to dynamically control an amount of total output power provided by the stabilizing group of energy resource systems to a power distribution network of the microgrid in order to stabilize one or more cyclic loads on the power distribution network and to maintain the non-stabilizing group of energy resource systems at a substantially constant load.

### BRIEF DESCRIPTION OF THE DRAWINGS

FIG. 1 shows a system according to one or more implementations.

FIG. 2 shows a microgrid according to one or more implementations.

FIG. 3 shows a block diagram of a first stage of a control method based on a load stabilization algorithm.

FIG. 4 shows a block diagram of a second stage of a control method based on a load stabilization algorithm.

FIG. 5 shows a block diagram of a third stage of a control method based on a load stabilization algorithm.

FIG. 6 is a diagram of example components of the microgrid controller associated with improved peak microgrid load dispatch.

### DETAILED DESCRIPTION

This disclosure relates to a power distribution system, which is applicable to any system that distributes and/or receives power via a power grid. Some aspects relate to a microgrid controller that is configured to control one or more components and/or systems associated with the microgrid, including energy resource systems and/or loads. The microgrid controller may control a state of the microgrid based on one or more conditions being satisfied.

The microgrid controller executes program code (e.g., instructions) of a load stabilization algorithm (e.g., load smoothing algorithm) to provide power from one or more energy storage systems to stabilize large cyclic loads and keep other energy resource systems at relatively constant loads. The microgrid controller applies a parallel approach for addressing unstable and stable loads. As a result, a power quality provided by the microgrid may be improved.

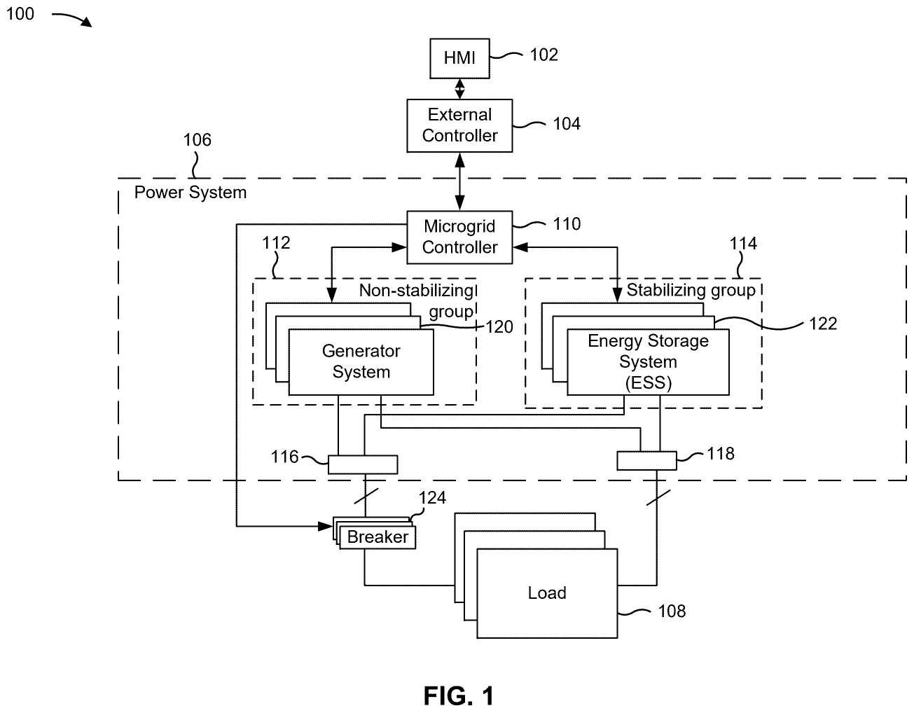

FIG. 1 shows a system 100 according to one or more implementations. The system 100 may include a human-to-machine interface (HMI) 102, an external controller 104, a power system 106, and one or more loads 108.

The power system 106 may be a microgrid or other type of electrical power distribution system that may provide power to the one or more loads 108. In some cases, the power system 106 may be an off-grid electrical power distribution system. In some cases, the power system 106 may be configurable to operate in a grid-connected mode and in a stand-alone mode. The power system 106 may include a microgrid controller 110, a non-stabilizing group of energy resource systems 112 (e.g., a non-stabilizing group of DERs), a stabilizing group of energy resource systems 114 (e.g., a stabilizing group of DERs), and interfaces 116 and 118. Generally, “off-grid” may mean that the electrical power distribution system is not connected to a larger electrical power distribution system run by, for example, an electric utility or other large-scale electric power generation plant that serves electricity to a geographic area, campus, compound, etc. However, techniques disclosed herein may still be applied to electrical power distribution systems that are connected to larger electrical power distribution systems. For instance, the larger electrical power distribution systems may operate as a power source in a primary provider role or secondary provider role, while the power system 106 may operate as a power source in the other of the primary provider role or secondary provider role.

The non-stabilizing group of energy resource systems 112 may include one or more energy generator systems 120. Each energy generator system 120 may include a power generator (e.g., an engine-generator, a fuel cell, a PV cell, or other power generating system) and a local generator controller communicatively coupled to the microgrid controller 110. Thus, each energy generator system 120 may generate power from a respective power source. Each local generator controller may control how much power a respective power generator generates, control a rate of power distribution, and/or obtain status information corresponding to the respective power generator. Each local generator controller may be controlled by the microgrid controller 110.

The stabilizing group of energy resource systems 114 may include one or more energy storage systems (ESSs) 122. Each energy storage system 122 may include an electric storage device (e.g., one or more batteries and/or capacitors) and a local ESS controller communicatively coupled to the microgrid controller 110. Each local ESS controller may control a flow of power into or out of a respective electric storage device, including charging of the respective electric storage device and discharging of the respective electric storage device, control a rate of power flow, and/or obtain status information corresponding to the respective electric storage device, such as state-of-charge (SOC), state-of-health (SOH), discharge limit, and other device parameters. Each local ESS controller may be controlled by the microgrid controller 110.

The system 100 may also include one or more breakers 124 (e.g., distribution breakers or switches) that may be individually controlled by the microgrid controller 110 to connect a respective load 108 to the power system 106 or disconnect the respective load 108 from the power system 106. The one or more breakers 124 may be part of one or both interfaces 116 and 118.

The HMI 102 may include one or more processors, and may be configured to receive and process one or more inputs from a user, such as an operator. Additionally, the HMI 102 may be configured to provide one or more prompts or outputs to the user. Thus, the HMI 102 may be a user terminal configured to interact with a user to process information and/or commands provided by the user, provide information to the user (e.g., status information), and/or perform one or more tasks or functions in response to processing the information and/or commands provided by the user. The HMI 102 may be communicatively coupled to the external controller 104, which may be communicatively coupled to the microgrid controller 110. In some implementations, the HMI 102 may be communicatively coupled directly to the microgrid controller 110. The external controller 104 may send commands to and receive information from the microgrid controller 110. For example, the external controller 104 may send commands to the microgrid controller 110 based on information received from the HMI 102. Thus, the external controller 104 may be a user-commanded controller. The external controller 104 may be integrated with the HMI 102. The external controller 104 may be a controller of a larger electrical power distribution system (e.g., a macrogrid, a power generation plant, and/or electric utility provider).

The power system 106 may provide electrical power to the one or more loads 108. Generally, the power system 106 may provide alternating current (AC) power at a particular voltage and a particular current. The microgrid controller 110 may control one or more energy storage systems 122 to instantaneously inject power when power is needed by the power system 106 or instantaneously absorb surplus power generated by the power system 106. Accordingly, one of more electric storage devices of the energy storage systems 122 may act as a power consumer on one or more energy generator systems 120 or as a power source for the one or more energy generator systems 120, to thereby ensure that system bus frequencies of the non-stabilizing group of energy resource systems 112 are maintained at a nominal value. In other words, the microgrid controller 110 may control the stabilizing group of energy resource systems 114 to stabilize loads of the non-stabilizing group of energy resource systems 112 in order to maintain the non-stabilizing group of energy resource systems 112 at a relatively constant load, which may reduce a recurrence of frequency deviations from the nominal value.

The microgrid controller 110 may be integrated with, or separate from (but connected to), the interfaces 116 and 118, the energy generator systems 120, and the energy storage systems 122, or combinations thereof. In this manner, a user may, through interaction with the HMI 102, add or remove energy generator systems 120 to increase/reduce system power generation and/or add or remove energy storage systems 122 to increase/reduce system energy storage capacity, in accordance with a user's preference. For instance, a user may prefer to add additional energy generator systems 120 and/or add additional energy storage systems 122 to increase load capacity if additional loads 108 are expected to be connected to the power system 106, or remove energy generator systems 120 and/or remove energy storage systems 122 to decrease load capacity if loads 108 are expected to be disconnected from the power system 106. Additionally, the microgrid controller 110 may be configured to add or remove energy generator systems 120 and/or add or remove energy storage systems 122 from the power system 106 based one or more conditions being satisfied. In some cases, the microgrid controller 110 may be configured to add or remove energy generator systems 120 and/or add or remove energy storage systems 122 from the power system 106 based on a schedule.

The one or more loads 108 may be any device that can connect to a power distribution system, such as the power system 106, to receive electrical power. Examples of loads may include heavy machinery (e.g., electric mining machines, haulers, etc.), personal devices, appliances, heating, ventilation, and air conditioning (HVAC) systems, industrial drills, personal residence electrical distribution systems, etc. The loads 108 may include one or more non-stable loads, such as one or more cyclic loads. The loads 108 may include unidirectional loads (e.g., loads that can only receive power from the power system 106), bi-directional loads (e.g., loads that can both receive power from the power system 106 and provide power to the power system 106), charging loads (e.g., loads that include a chargeable electric battery), essential loads (e.g., loads that require uninterrupted service), and/or non-essential loads (e.g., loads that do not require uninterrupted service). Loads may be assigned different priorities based on load type, load classification, and/or operation state or mode.

Generally, the one or more loads 108 may receive the power from the power system 106 and use the power in accordance with the operations of the one or more loads 108. Users of the power system 106 and the one or more loads 108 may connect/disconnect the one or more loads 108 by electrically connecting the one or more loads 108 to the interfaces 116 and 118 of the power system 106. For instance, the interfaces 116 and 118 may have AC plugs/sockets to connect the one or more loads 108 in parallel to the one or more energy generator systems 120 and the one or more energy storage systems 122 of the power system 106. One or more loads 108 may include a local load controller that may collect load information and transmit the load information to the microgrid controller 110. Load information may include information indicating a load type, a load classification, and/or an operation state or mode of a load 108 (e.g., charging state, moving state, etc.). Load information may include load data of a load, such as maximum load and minimum load. For chargeable loads, load information may include maximum charging load, maximum state of charge, minimum state of charge, current state of charge, and usable discharge energy as a function of the current state of charge. Load information may be received by the microgrid controller 110 via the interfaces 116 and 118, which may include one or more communication interfaces coupled to the microgrid controller 110.

The interfaces 116 and 118 may also have a plurality of generator connections and a plurality of energy store connections. The plurality of generator connections may be hardwired electrical connections and/or AC plugs/sockets to connect the one or more energy generator systems 120 in parallel to the at least one load 108 and the one or more energy storage systems 122. The plurality of energy store connections may be hardwired electrical connections and/or AC plugs/sockets to connect the one or more energy storage systems 122 in parallel to the one or more loads 108 and the one or more energy generator systems 120. For instance, the power system 106 may or may not allow addition/removal of energy generator systems 120 and/or addition/removal of energy storage systems 122. Therefore, depending on a configuration, the interfaces 116 and 118 may include: (1) hardwired electrical connections that connect the at least one energy generator system 120; (2) AC plugs/sockets to connect/disconnect the at least one energy generator system 120; (3) hardwired electrical connections that connect the at least one energy storage system 122; and/or (4) AC plugs/sockets to connect/disconnect the at least one energy storage system 122. The interfaces 116 and 118 may be coupled to a system bus (e.g., a power bus) of the power system 106. The system bus may enable one of more of the energy storage systems 122 to absorb power from one or more energy generator systems 120 and/or one or more loads 108 (e.g., for charging and/or storing power).

The one or more energy generator systems 120 may also include communication interfaces. The communication interfaces of the one or more energy generator systems 120 may enable the one or more energy generator systems 120 to communicate with the microgrid controller 110. For instance, the one or more energy generator systems 120 may be connected to the microgrid controller 110 by wired or wireless communication. The one or more energy generator systems 120 may provide the microgrid controller 110 with generator data. The generator data, for each of the one or more energy generator systems 120, may include load data and/or generator parameters. The load data may include a current (e.g., instantaneous) load seen by the one or more energy generator systems 120 and/or past load data (if one or more energy generator systems 120 store such data locally). The current load/past load data may include voltage (e.g., in volts) and/or current (e.g., in amperes) measured by one or more sensor components included in an energy generator system 120. The generator parameters may include a generator set maximum threshold value and a generator set minimum threshold value. Alternatively, to reduce transmission bandwidth, the generator data may omit the generator parameters, and the one or more energy generator systems 120 may transmit the generator parameters during an initial configuration process between the one or more energy generator systems 120 and the microgrid controller 110. The generator set maximum threshold value and the generator set minimum threshold value may indicate a maximum power load and a minimum power load, respectively, that a generator of an energy generator system 120 may support.

The one or more energy storage systems 122 may be any energy storage device that can store and output AC power. For instance, the one or more energy storage systems 122 may include at least one electrical-chemical energy storage (e.g., a battery), electrical energy storage (e.g., a capacitor, a supercapacitor, or a superconducting magnetic energy storage), mechanical energy storage (e.g., a fly wheel, a pump system), and/or any combination thereof. The one or more energy storage systems 122 may include inverters (individually or collectively) so that the one or more energy storage systems 122 may operate as a power consumer or a power source. The one or more energy storage systems 122 may also include electronic control mechanisms to control (1) how much load the one or more energy storage systems 122 draw, or (2) how much AC power the one or more energy storage systems 122 output.

The one or more energy storage systems 122 may also include communication interfaces. The communication interfaces of the one or more energy generator systems 120 may enable the one or more energy storage systems 122 to communicate with the microgrid controller 110. For instance, the one or more energy storage systems 122 may be connected to the microgrid controller 110 by wired or wireless communication. The one or more energy storage systems 122 may provide the microgrid controller 110 with energy storage data and may receive instructions from the microgrid controller 110.

The energy storage data may include, for each of the at least one energy store, a current energy level (e.g., kilowatt-hours currently stored), total energy storage capacity (e.g., kilowatt-hours of capacity), and/or discharge/charge parameters. The current energy level may be measured by a battery meter of an energy storage. The battery meter may one or combinations of a voltmeter, an amp-hour meter, and/or an impedance-based meter. The discharge/charge parameters may indicate an amount of discharge power and an amount of charge power for a respective energy storage device of the one or more energy storage systems 122. Alternatively, to reduce transmission bandwidth, the energy storage data may omit the discharge/charge parameters, and the one or more energy storage systems 122 may transmit the discharge/charge parameters when the one or more energy storage systems 122 are first connected to the microgrid controller 110.

The one or more energy storage systems 122 may receive requests (e.g., instructions) for the energy storage data to provide the energy storage data and/or continuously provide the energy storage data to the microgrid controller 110. The instructions may include energy storage dispatch (ESD) instructions. An ESD instruction may include an instruction to inject power to a system bus of the power system 106 or absorb power from the system bus of the power system 106. ESD instructions may be provided in control signals (e.g., communication signals that provide the ESD instructions). At least one ESD instruction may be utilized to rapidly stabilize the load, thereby stabilizing the bus frequency of the power system 106 in a time efficient manner, rather than attempting to stabilize the load using the one or more energy generator systems 120 alone. The one or more energy storage systems 122 may control the inverters and the electronic control mechanisms to control (1) quantity of load drawn by the one or more energy storage systems 122, or (2) the amount of AC power output produced by the one or more energy storage systems 122, in accordance with the ESD instructions.

The microgrid controller 110 may include at least one memory device (e.g., one or more memories) for storing instructions (e.g., program code); at least one processor for executing the instructions from the memory device to perform a set of desired operations; and a communication interface (e.g., coupled to a communication bus) for facilitating the communication between various system components. The instructions may be computer-readable instructions for executing a control application. The communication interface of the microgrid controller 110 may enable the microgrid controller 110 to communicate with the one or more energy generator systems 120 and the one or more energy storage systems 122. The microgrid controller 110, while executing the control application, may receive the generator data and the energy storage data (e.g., energy resource information), process the generator data and the energy storage data to generate one or more ESD instructions, and output the ESD instructions to one or more energy generator systems 120 and/or to one or more energy storage systems 122, so that the one or more energy generator systems 120 are protected from transient changes in load.

To process the generator data and the energy storage data to generate the ESD instructions, the control application may include a load stabilization function and/or an SOC function. The control application may also include a generator set limit function and/or energy store discharge/charge limit function to generate the ESD instructions. In some cases, the load stabilization function may be activated while the power system 106 is configured in stand-alone mode in order to provide off-grid load stabilization. Generally, the load stabilization function may ensure that system bus frequencies of the one or more energy generator systems 120 are maintained at a nominal value by causing an amount of power to be absorbed/injected by the one or more energy storage systems 122. The amount of power may be determined based on a difference between an instantaneous load and a moving average of the load. Meanwhile, the SOC function may ensure that the one or more energy storage systems 122 are charged to a target SOC. The target SOC may enable the at least one energy storage system 122 to provide long term beneficial use to the system 100, such as having a range of operation usable by the power system 106, and/or avoid degradation ranges of the one or more energy storage systems 122.

The instructions may include a load stabilization algorithm that may be executed by the microgrid controller 110 to increase a microgrid power quality by reducing the recurrence of frequency deviations that are caused by repetitive load steps (e.g., caused by one or more cyclic loads). Reactive and/or active may be used as a qualifier for loads, where reactive loads contribute to the stabilization algorithm in addition to the active or real loads. The communication interface of the microgrid controller 110 may receive load information corresponding to a current load demand of the loads 108 connected to the microgrid and output one or more control signals (e.g., ESD instructions) for controlling a plurality of energy resource systems associated with the microgrid. The plurality of energy resource systems may include the non-stabilizing group of energy resource systems 112 and the stabilizing group of energy resource systems 114.

One or more processors of the microgrid controller 110 may execute the load stabilization algorithm (e.g., execute instructions associated with the load stabilization algorithm) to generate the one or more control signals based on the load information. Executing the load stabilization algorithm may include generating, based on the load information, one or more first control signals to dynamically control an amount of total output power provided by the stabilizing group of energy resource systems 114 to a power distribution network of the microgrid in order to stabilize one or more cyclic loads on the power distribution network and to maintain the non-stabilizing group of energy resource systems 112 at a substantially constant load.

Executing the load stabilization algorithm may further include generating, based on a total load of the plurality of loads 108, the one or more first control signals to control a first total output power provided by the stabilizing group of energy resource systems 114 to the power distribution network of the microgrid, and generating, based on the total load of the plurality of loads 108, one or more second control signals to control a second total output power provided by the non-stabilizing group of energy resource systems 112 to the power distribution network of the microgrid. Executing the load stabilization algorithm may further include monitoring an SOC of the stabilizing group of energy resource systems 114, calculating a bias power to maintain the SOC of the stabilizing group of energy resource systems within a target range, and calculating the first total output power and the second total output power based on the bias power. The SOC of the stabilizing group of energy resource systems 114 may be a cumulative SOC of the stabilizing group of energy resource systems 114. In some cases, the target range may be a single SOC value (e.g., an SOC target).

Executing the load stabilization algorithm may further include calculating the total load of the plurality of loads 108 based on the load information; calculating a first target load for the non-stabilizing group of energy resource systems 112 and a second target load for the stabilizing group of energy resource systems 114, where a sum of the first target load and the second target load is equal to the total load; measuring the SOC of the stabilizing group of energy resource systems 114; calculating the bias power to maintain the SOC of the stabilizing group of energy resource systems 114 within the target range; calculating the first total output power for the non-stabilizing group of energy resource systems 112 based on the first target load and the bias power; calculating the second total output power for the stabilizing group of energy resource systems 114 based on the second target load and the bias power; controlling, based on the first total output power, the non-stabilizing group of energy resource systems 112 to produce the first total output power; and controlling, based on the second total output power, the stabilizing group of energy resource systems 114 to produce the second total output power.

Executing the load stabilization algorithm may further include the microgrid controller 110 receiving a moving average window setpoint (e.g., from the HMI 102 or external controller 104), calculating a moving average of the total load based on the total load and the moving average window setpoint, and calculating the first target load for the non-stabilizing group of energy resource systems 112 based on the moving average of the total load. Since the sum of the first target load and the second target load is equal to the total load, the microgrid controller 110 may also calculate the second target load by subtracting the first target load from the total load.

Executing the load stabilization algorithm may further include calculating a first total allocated load for the non-stabilizing group of energy resource systems 112 based on the first target load and the bias power, calculating a second total allocated load for the stabilizing group of energy resource systems 114 based on the second target load and the bias power, and calculating the first total output power and the second total output power based on the second total allocated load relative to a discharge power limit (e.g., a kilowatt (kW) limit) of the stabilizing group of energy resource systems 114. Executing the load stabilization algorithm may further include, based on the second total allocated load exceeding the discharge power limit of the stabilizing group of energy resource systems 114: setting the first total output power to a sum of the first total allocated load and the second total allocated load, minus the discharge power limit of the stabilizing group of energy resource systems 114, and setting the second total output power to the discharge power limit of the stabilizing group of energy resource systems 114. Executing the load stabilization algorithm may further include, based on the second total allocated load being less than a charge power limit of the stabilizing group of energy resource systems 114: setting the first total output power to a sum of the first total allocated load, the second total allocated load, and the charge power limit of the stabilizing group of energy resource systems 114, and setting the second total output power to the charge power limit of the stabilizing group of energy resource systems 114. The first total allocated load may be a subtraction of the bias power from the first target load, and the second total allocated load may be a sum of the second target load and the bias power.

Furthermore, the microgrid may be configured, while the microgrid controller 110 is executing the load stabilization algorithm, in a stand-alone state, during which the microgrid is disconnected from an external power distribution system. In other words, the microgrid controller 110 may be configured to set the microgrid in the stand-alone state when executing the load stabilization algorithm. Moreover, the plurality of loads 108 may include at least one non-stable load.

The instructions may include a sequential dispatch algorithm that may be executed by the microgrid controller 110. The sequential dispatch algorithm may be part of the load stabilization algorithm. One or more processors of the microgrid controller 110 may execute the sequential dispatch algorithm (e.g., execute instructions associated with the sequential dispatch algorithm) to maintain the SOC of the stabilizing group of energy resource systems 114 within the target range. For example, executing the sequential dispatch algorithm may include generating, based on the SOC of the stabilizing group of energy resource systems 112 being less than a minimum threshold, the one or more second control signals to control at least one energy resource system (e.g., one or more energy generator systems 120) of the non-stabilizing group of energy resource systems 112 to provide the bias power to the stabilizing group of energy resource systems 114 in order to increase the SOC of the stabilizing group of energy resource systems 114. In addition, executing the sequential dispatch algorithm may include generating, based on the SOC of the stabilizing group of energy resource systems 114 being greater than a maximum threshold, the one or more first control signals to control at least one energy resource system (e.g., one or more energy storage systems 122) of the stabilizing group of energy resource systems 114 to provide the bias power to a power distribution network of the microgrid in order to decrease the SOC of the stabilizing group of energy resource systems 114. The target range of the SOC may be defined by the minimum threshold and the maximum threshold. Alternatively, the minimum threshold and the maximum threshold may be SOC limits that are set within the target range.

One or more energy generator systems 120 may include an engine-generator that provides AC power to the power system 106, which may provide the AC power to the at least one load 108. Generally, an engine-generator may be any device that converts motive power (mechanical energy) into electrical power to output the AC power. An engine-generator may be a gas turbine electrical generator. In such gas turbine electrical generators, fast changes in load from the at least one load 108 may cause a system bus frequency to deviate from a nominal value. The system bus frequency may be a frequency of electrical components of the generator. For instance, such gas turbine electrical generators may have isochronous frequency control governors that may try to maintain the system bus frequency at the nominal value in response to changes of the load of the one or more loads 108. Therefore, during a transient load charge (e.g., a load transient), the system bus frequency may change as the load on the engine-generator changes. However, a rate of return of the system bus frequency back to the nominal value is slower than a desired rate due to an inertia of motion of physical components (e.g., a rotor of a stator-rotor) of the engine-generator. The slow rate of return may reduce power quality of the power system 106. The power quality of the power system 106 may be determined based on the voltage, frequency, and waveform of the power output to the one or more loads 108. A higher power quality may ensure continuity of service for the one or more loads 108, such that the one or more loads 108 are able to properly function as intended. A lower power quality may cause the one or more loads 108 to malfunction, fail prematurely, or not operate at all.

Therefore, avoiding load transients may be beneficial in providing better power quality. However, generally, controlling a load of the one or more loads 108 may not be possible or desirable. Instead, the microgrid controller 110 may control the one or more energy storage systems 122 of the stabilizing group of energy resource systems 114 to act as a power consumer or as an energy source, so that the one or more energy generator systems 120 of the non-stabilizing group of energy resource systems 112 may maintain the system bus frequency at the nominal value, thereby ensuring better power quality. For example, the microgrid controller 110 may execute the load stabilization algorithm in order to control the stabilizing group of energy resource systems 114, to stabilize one or more cyclic loads on the power distribution network and to maintain the non-stabilizing group of energy resource systems 112 at a substantially constant load, which may reduce repeat occurrences of frequency deviations from the nominal value.

The microgrid controller 110 may control the one or more energy storage systems 122 to act as a near instantaneous load or energy source, so that the one or more energy generator systems 120 may maintain the system bus frequency at the nominal value, thereby ensuring better power quality. In one aspect of this disclosure, the microgrid controller 110 may control the one or more energy storage systems 122 to instantaneously inject power when power is needed by the at least one load 108, or instantaneously absorb surplus power generated by the one or more energy generator systems 120. Accordingly, the microgrid controller 110 regulates the power supply such that an exact amount of desired power supply flows in or out of the power system 106 at any given time. The instantaneous injecting/absorbing of power may be performed to control the amount of transient load seen by the power system 106 and thus stabilize the load and resulting system bus frequency of the one or more energy generator systems 120.

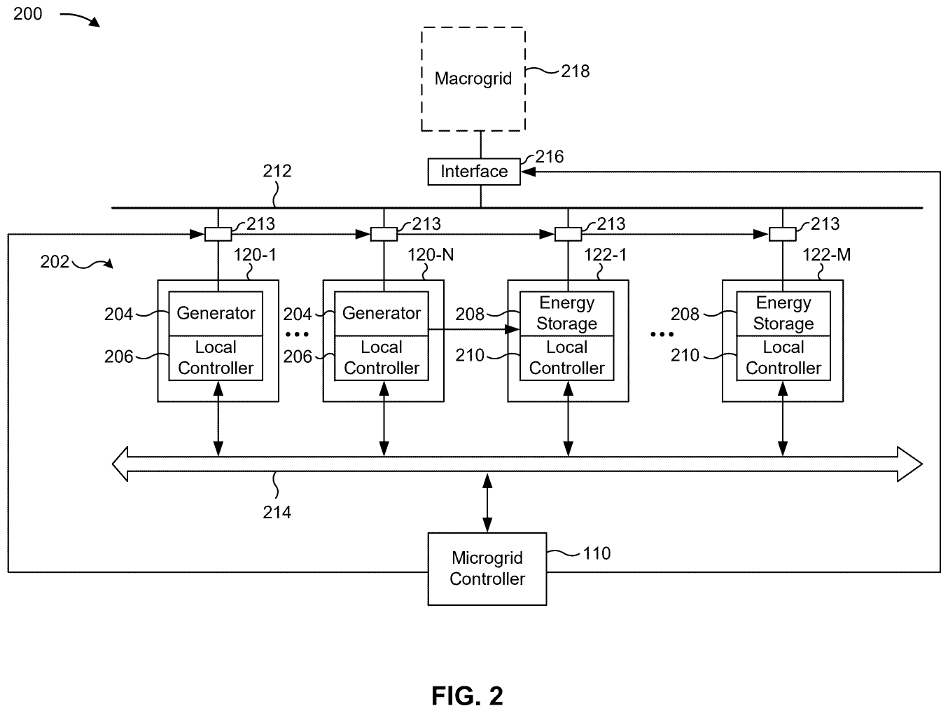

FIG. 2 shows a microgrid 200 according to one or more implementations. The microgrid 200 may be an example of the power system 106 described in connection with FIG. 1. The microgrid 200 may include a plurality of DERs 202. The plurality of DERs 202 may include N energy generator systems 120 and M energy storage systems 122, where N and M are integers greater than zero. For example, the plurality of DERs 202 may include a first energy generator system 120-1 and an N^{th} energy generator system 120-N. Additionally, the plurality of DERs 202 may include a first energy storage system 122-1 and an M^{th} energy storage system 122-M. Each energy generator system 120 may include a power generator 204 and a local generator controller 206. Each energy storage system 122 may include an electric storage device 208 (e.g., one or more batteries and/or capacitors) and a local ESS controller 210.

Each energy generator system 120 may be coupled to a power bus 212 for providing power to one or more loads connected to the power bus 212. Additionally, each energy storage system 122 may be coupled to the power bus 212 for providing power to or absorbing power from the power bus 212 (e.g., for providing power to or absorbing power from one or more components, such as one or more loads and/or one or more energy generator systems 120 connected to the power bus 212).

The microgrid 200 may also include the microgrid controller 110 that is communicatively coupled to the local controllers (e.g., local generator controllers 206 and local ESS controllers 210) of each DER 202 across a communication bus 214. The communication bus 214 may also enable the microgrid 200 to communicate with one or more loads and/or one or more load management systems (e.g., charging systems, fleet management systems, local load controllers, etc.). In some cases, two or more communication buses 214 may be provided. For example, one communication bus may be provided to communicate with local controllers and another communication bus may be provided to communicate with one or more loads and/or one or more load management systems.

Each local generator controller 206 may include any appropriate hardware, software, and/or firmware to sense and control a respective power generator 204, and send information to, and receive information from microgrid controller 110. For example, a local generator controller 206 may be configured to sense, determine, and/or store generator data of its respective power generator 204. The generator data may be sensed, determined, and/or stored in any conventional manner. Each local generator controller 206 may control whether a respective power generator 204 is connected to or disconnected from the power bus 212 (for example, based on an instruction or a control signal received from the microgrid controller 110).

Each local ESS controller 210 may include any appropriate hardware, software, and/or firmware to sense and control a respective electric storage device 208, and send information to, and receive information from microgrid controller 110. For example, a local ESS controller 210 may be configured to sense, determine, and/or store various characteristics of its respective electric storage device 208. Such characteristics of the respective electric storage device 208 may include, among others, a current SOC, a current energy, an SOC minimum threshold, an SOC maximum threshold, and a discharge limit of the respective electric storage device 208. These characteristics of respective electric storage device 208 may be sensed, determined, and/or stored in any conventional manner. Each local ESS controller 210 may control whether a respective electric storage device 208 is connected to or disconnected from the power bus 212 (for example, based on an instruction or a control signal received from the microgrid controller 110).

The microgrid controller 110 may receive or determine a need for charging or discharging of power from the microgrid 200, and may be configured to determine and send signals to allocate a total charge request and/or total discharge request across all of the plurality of DERs 202.

When performing the power allocation functions, the microgrid controller 110 may allocate a certain amount of power from each energy generator system 120 to one or more loads. When performing the power allocation functions, the microgrid controller 110 may allocate a total charge request and/or a total discharge request across the energy storage systems 122 as a function of a usable energy capacity of each energy storage system 122. The usable energy capacity corresponds to the capacity or amount of energy that an energy storage system 122 can receive in response to a total charging request (usable charge energy), or the capacity or amount of energy that an energy storage system can discharge in response to a total discharge request (usable discharge energy). The usable charge energy is a function of a maximum state of charge, current state of charge, and current energy of the energy storage system, and the usable discharge energy is a function of a minimum state of charge, and current energy of the energy storage system 122. The microgrid controller 110 may determine a usable charge/discharge capacity of each energy storage system 122 (e.g., SOC), a desired charge/discharge of each energy storage system 122, a remainder power of each energy storage system 122, and/or an SOH of each energy storage system 122.

Thus, the microgrid controller 110 regulates a power supply of the microgrid 200 such that an exact amount of desired power flows in or out of the power system 106 at any given time. The microgrid controller 110 may regulate the power supply of the microgrid 200 in cooperation with the local generator controllers 206 and the local ESS controllers 210. The microgrid controller 110 may transmit control signals (e.g., instructions) to the local generator controllers 206 and the local ESS controllers 210 to activate (e.g., to bring online), deactivate (to bring offline), or curtail (limit or regulate to a target output) one or more of the DERs 202. Additionally, or alternatively, the microgrid controller 110 may transmit control signals to one or more switches 213 to control a switch state (e.g., an on state or an off state) of the one or more switches 213, for example, to connect one or more DERs 202 to or disconnect one or more DERs 202 from the microgrid 200 (e.g., the power bus 212). The switches 213 may be integrated in one or both interfaces 116 and 118 described in connection with FIG. 1.

In some cases, two or more power buses 212 may be provided. For example, a power bus may be provided to couple one or more power generators 204 to one or more electric storage devices 208 for charging the one or more electric storage devices 208. For example, the microgrid controller 110 may selectively couple a power generator 204 to an electric storage device 208 to charge the electric storage device 208. Thus, the power bus 212 may be part of a power distribution network of the microgrid 200 that may include one or more power buses used to distribute power between loads and/or DERs 202.

The microgrid 200 may include an interface 216 for connecting the microgrid 200 to and disconnecting the microgrid 200 from an electrical power distribution system 218, such as a macrogrid. The interface 216 may include one or more electrical connections used for connecting the microgrid 200 to the electrical power distribution system 218. The interface 216 may include one or more switches or breakers that are controlled by the microgrid controller 110 for connecting the microgrid 200 to and disconnecting the microgrid 200 from the electrical power distribution system 218. For example, the one or more switches or breakers of the interface 216 may connect the power bus 212 (or another system bus) to or disconnect the power bus 212 (or another system bus) from the electrical power distribution system 218. Thus, the microgrid controller 110 may configure the microgrid 200 to operate in a grid-connected mode by connecting the microgrid 200 to the electrical power distribution system 218 or in a stand-alone mode by disconnecting the microgrid 200 from the electrical power distribution system 218.

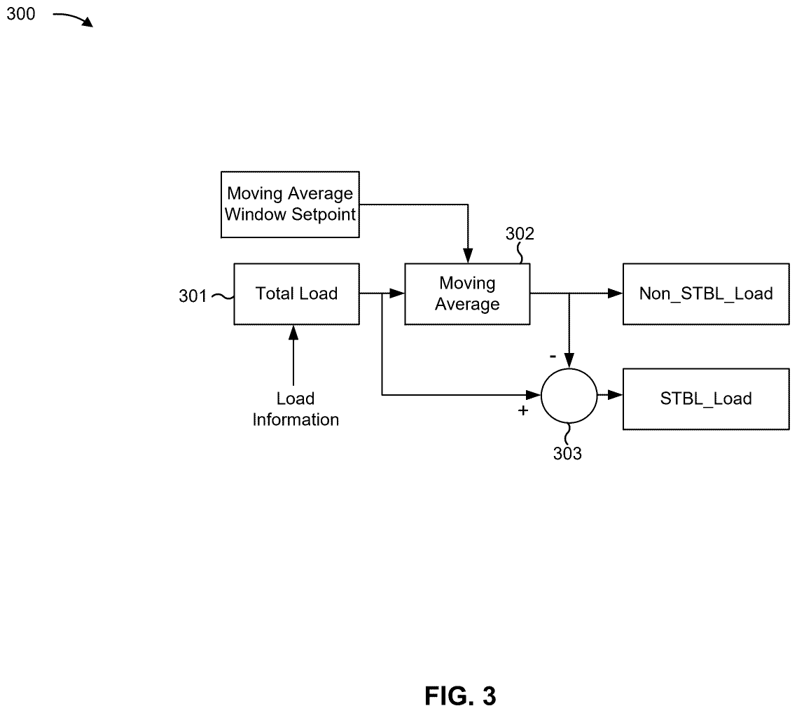

FIG. 3 shows a block diagram of a first stage 300 of a control method based on a load stabilization algorithm. The first stage 300 includes calculating the first target load Non_STBL_Load for the non-stabilizing group of energy resource systems 112, and calculating the second target load STBL_Load for the stabilizing group of energy resource systems 114. For example, processing unit 301 may receive the load information corresponding to the loads 108 connected to the microgrid, and calculate the total load of the loads 108 based on the load information. Processing unit 302 may receive the total load and the moving average window setpoint. The moving average window setpoint may be a time interval during which an average of the total load is calculated. The average is calculated on a continuous basis, and therefore may be referred to as a moving average. An operator may know a load period of a cyclic load and configure the moving average window setpoint to be greater than approximately twice the load period of the cyclic load. Processing unit 302 may calculate the first target load Non_STBL_Load for the non-stabilizing group of energy resource systems 112 as the moving average of the total load. Processing unit 302 may include a band pass filter or a low pass filter configured to remove noise from the moving average. The first target load Non_STBL_Load may be subtracted from the total load by processing unit 303 (e.g., a subtractor) to calculate the second target load STBL_Load.

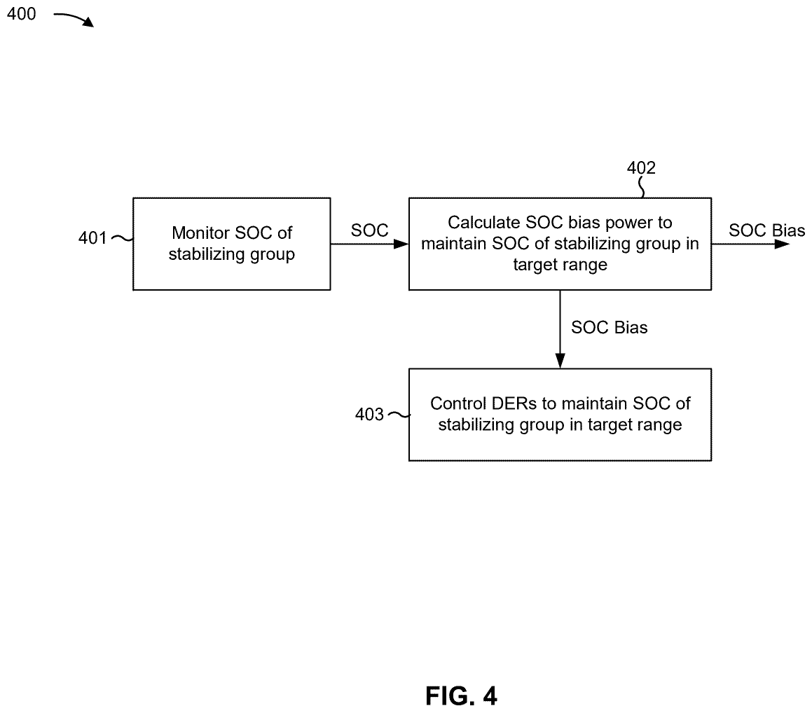

FIG. 4 shows a block diagram of a second stage 400 of a control method based on a load stabilization algorithm. The second stage 400 includes measuring an SOC of the stabilizing group of energy resource systems 114, and calculating a bias power SOCBias to maintain the SOC of the stabilizing group of energy resource systems 114 within a target range. For example, processing unit 401 may monitor (e.g., by measuring) the SOC of the stabilizing group of energy resource systems 114. Processing unit 402 may calculate the bias power SOCBias to maintain the SOC of the stabilizing group of energy resource systems 114 within the target range.

Additionally, processing unit 403 may control one or more DERs to maintain the SOC of the stabilizing group of energy resource systems 114 in the target range. For example, based on the SOC of the stabilizing group of energy resource systems 114 being less than a minimum threshold, processing unit 403 may generate the one or more second control signals to control at least one energy generator system 120 of the non-stabilizing group of energy resource systems 112 to provide the bias power SOCBias to the stabilizing group of energy resource systems 114 in order to increase the SOC of the stabilizing group of energy resource systems 114. Additionally, based on the SOC of the stabilizing group of energy resource systems 114 being greater than a maximum threshold, processing unit 403 may generate the one or more first control signals to control at least one energy storage system 122 of the stabilizing group of energy resource systems 114 to provide the bias power SOCBias to a power distribution network of the microgrid in order to decrease the SOC of the stabilizing group of energy resource systems 114.

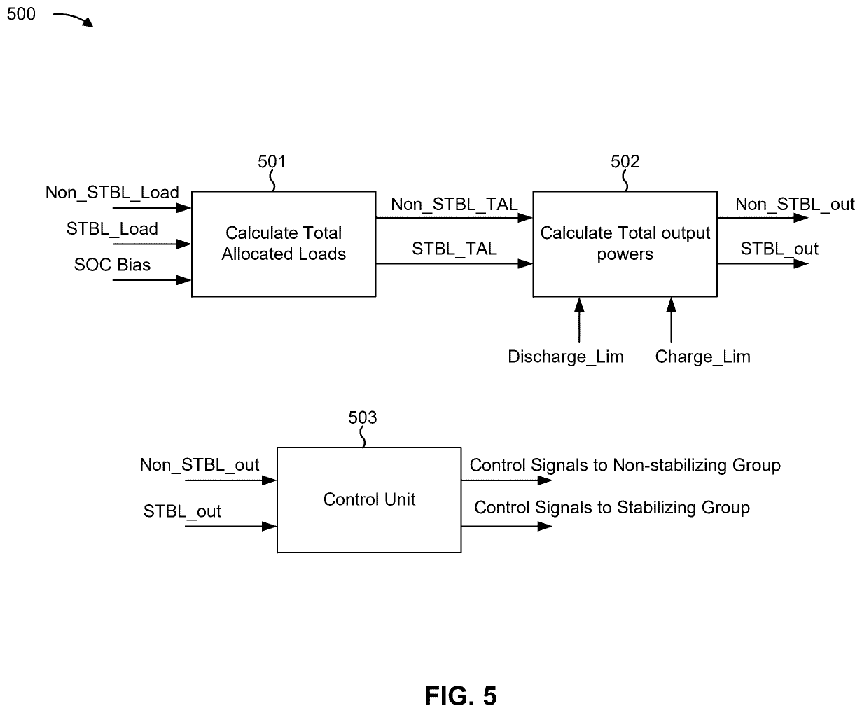

FIG. 5 shows a block diagram of a third stage 500 of a control method based on a load stabilization algorithm. The third stage 500 includes calculating a first total output power Non_STBL_out for the non-stabilizing group of energy resource systems 112 based on the first target load Non_STBL_Load and the bias power SOCBias; calculating a second total output power STBL_out for the stabilizing group of energy resource systems 114 based on the second target load STBL_Load and the bias power SOCBias; generating, based on the first total output power Non_STBL_out, one or more first control signals to control an operation of the non-stabilizing group of energy resource systems 112 to produce the first total output power Non_STBL_out; and generating, based on the second total output power STBL_out, one or more second control signals to control an operation of the stabilizing group of energy resource systems 114 to produce the second total output power STBL_out.

For example, processing unit 501 may receive the first target load Non_STBL_Load, the second target load STBL_Load, and the bias power SOCBias, calculate a first total allocated load Non_STBL_TAL for the non-stabilizing group of energy resource systems 112 based on the first target load Non_STBL_Load and the bias power SOCBias (e.g., Non_STBL_TAL=Non_STBL_Load−SOCBias), and calculate a second total allocated load STBL_TAL for the stabilizing group of energy resource systems 114 based on the second target load STBL_Load and the bias power SOCBias (e.g., STBL_TAL=STBL_Load+SOCBias). Thus, a load allocation between the non-stabilizing group of energy resource systems 112 and the stabilizing group of energy resource systems 114 is adjusted based on the bias power SOCBias.

Processing unit 502 may receive the first total allocated load Non_STBL_TAL and the second total allocated load STBL_TAL, as well as a stable group discharge power limit Discharge_Lim (e.g., a discharge kW limit for the stabilizing group of energy resource systems 114) and a stable group charge power limit Charge_Lim (e.g., a charge kW limit for the stabilizing group of energy resource systems 114). Processing unit 502 may calculate the first total output power Non_STBL_out and the second total output power STBL_out based on the second total allocated load STBL_TAL relative to the discharge power limit Discharge_Lim of the stabilizing group of energy resource systems 114.

For example, based on the second total allocated load STBL_TAL exceeding the discharge power limit Discharge_Lim of the stabilizing group of energy resource systems 114, processing unit 502 may set the first total output power Non_STBL_out to a sum of the first total allocated load Non_STBL_TAL and the second total allocated load STBL_TAL, minus the discharge power limit Discharge_Lim of the stabilizing group of energy resource systems 114 (e.g., Non_STBL_out=Non_STBL_TAL+STBL_TAL−Discharge_Lim), and may set the second total output power STBL_out to the discharge power limit Discharge_Lim of the stabilizing group of energy resource systems 114 (e.g., STBL_out=Discharge_Lim).

In addition, based on the second total allocated load STBL_TAL being less than the charge power limit Charge_Lim of the stabilizing group of energy resource systems 114, processing unit 502 may set the first total output power Non_STBL_out to a sum of the first total allocated load Non_STBL_TAL, the second total allocated load STBL_TAL, and the charge power limit Charge_Lim of the stabilizing group of energy resource systems 114 (e.g., Non_STBL_out=Non_STBL_TAL+STBL_TAL+Charge_Lim), and may set the second total output power STBL_out to the charge power limit Charge_Lim of the stabilizing group of energy resource systems 114.

Control unit 503 may generate, based on the first total output power Non_STBL_out, one or more first control signals to control an operation of the non-stabilizing group of energy resource systems 112 to produce the first total output power Non_STBL_out. Additionally, control unit 503 may generate, based on the second total output power STBL_out, one or more second control signals to control an operation of the stabilizing group of energy resource systems 114 to produce the second total output power STBL_out.

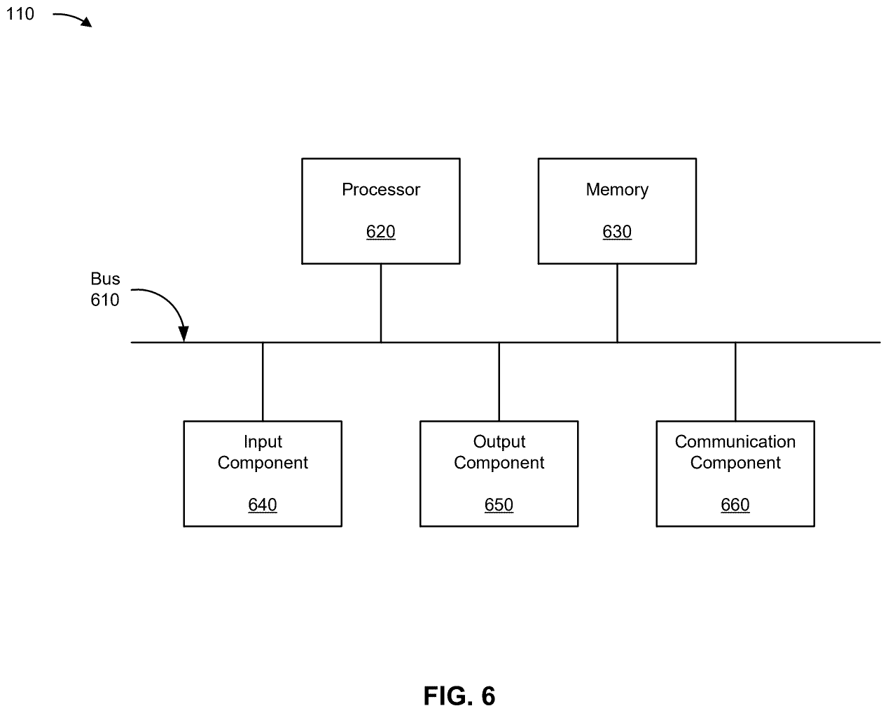

FIG. 6 is a diagram of example components of the microgrid controller 110 associated with improved peak microgrid load dispatch. The microgrid controller 110 may include a bus 610, a processor 620, a memory 630, an input component 640, an output component 650, and/or a communication component 660.

The bus 610 may include one or more components that enable wired and/or wireless communication among the components of the microgrid controller 110. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus.

The processor 620 may include a central processing unit a microprocessor, a controller, a microcontroller, a digital signal processor, a field-programmable gate array, an application-specific integrated circuit, and/or another type of processing component. The processor 620 may be implemented in hardware, firmware, or a combination of hardware and software. The processor 620 may include one or more processors capable of being programmed to perform one or more operations or processes described elsewhere herein.

The memory 630 may store information, one or more instructions, and/or software (e.g., one or more software applications) related to the operation of the microgrid controller 110. The memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the microgrid controller 110 to receive input, load information, generator data, energy storage data, status information, scheduling information, and/or control signals (e.g., control signals from a macrogrid controller). The output component 650 may enable the microgrid controller 110 to provide output, such as one or more control signals for controlling loads, energy storage systems, breakers, switches, and other components associated with the microgrid described herein. The communication component 660 may enable the microgrid controller 110 to communicate with other devices via a wired connection and/or a wireless connection. For example, the communication component 660 may include a receiver, a transmitter, and/or a transceiver.

The microgrid controller 110 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. Execution of the set of instructions, by one or more processors 620, may cause the one or more processors 620 and/or the microgrid controller 110 to perform one or more operations or processes described herein. Hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

### INDUSTRIAL APPLICABILITY

A total load increases on a microgrid when certain utility devices come online periodically. The increase in the total load causes a frequency deviation on the microgrid from a nominal value, and a power quality provided by the microgrid is reduced.

The microgrid controller 110 is configured to reduce a recurrence of frequency deviations caused by repetitive load steps by providing power from the stabilizing group of energy resource systems 114 to stabilize one or more large cyclic loads and maintain the non-stabilizing group of energy resource systems 112 at a relatively constant load. The period of the cyclic load is known and, accordingly, the moving average is configured. Desired power from the non-stabilizing group of energy resource systems 112 and the stabilizing group of energy resource systems 114 is calculated. Initially, the target load for non-stabilizing group and the target load for the stabilizing group are calculated. Then, an SOC bias required to maintain a target SOC on the stabilizing group is calculated. Based on the SOC bias, load allocation between the stabilizing group and the non-stabilizing group is adjusted. As a result, the power quality provided from the microgrid is increased. A load stabilization algorithm may be executed by the microgrid controller 110 to increase the power quality by reducing the recurrence of frequency deviations caused by the repetitive load steps. The microgrid controller 110 may apply a parallel approach for addressing unstable and stable loads.

What is claimed is:

1. A microgrid controller of a microgrid, comprising:
one or more memories configured to store a load stabilization algorithm;
a communication interface configured to receive load information corresponding to a plurality of loads connected to the microgrid and output one or more control signals for controlling a plurality of energy resource systems associated with the microgrid, wherein the plurality of energy resource systems includes a non-stabilizing group of energy resource systems and a stabilizing group of energy resource systems; and
one or more processors, coupled to the one or more memories, configured to execute the load stabilization algorithm to generate the one or more control signals based on the load information, wherein executing the load stabilization algorithm comprises:
calculating a total load of the plurality of loads based on the load information,
calculating a first target load for the non-stabilizing group of energy resource systems and a second target load for the stabilizing group of energy resource systems, wherein a sum of the first target load and the second target load is equal to the total load,
measuring a state-of-charge (SOC) of the stabilizing group of energy resource systems,
calculating a bias power to maintain the SOC of the stabilizing group of energy resource systems within a target range,
calculating a first total output power for the non-stabilizing group of energy resource systems based on the first target load and the bias power,
calculating a second total output power for the stabilizing group of energy resource systems based on the second target load and the bias power,
generating, based on the first total output power, one or more first control signals to control an operation of the non-stabilizing group of energy resource systems to produce the first total output power, and
generating, based on the second total output power, one or more second control signals to control an operation of the stabilizing group of energy resource systems to produce the second total output power.

2. The microgrid controller of claim 1, wherein executing the load stabilization algorithm further comprises:
calculating a first total allocated load for the non-stabilizing group of energy resource systems based on the first target load and the bias power,
calculating a second total allocated load for the stabilizing group of energy resource systems based on the second target load and the bias power, and
calculating the first total output power and the second total output power based on the second total allocated load relative to a discharge power limit of the stabilizing group of energy resource systems.

3. The microgrid controller of claim 2, wherein executing the load stabilization algorithm further comprises:
based on the second total allocated load exceeding the discharge power limit of the stabilizing group of energy resource systems:
setting the first total output power to a sum of the first total allocated load and the second total allocated load, minus the discharge power limit of the stabilizing group of energy resource systems, and
setting the second total output power to the discharge power limit of the stabilizing group of energy resource systems.

4. The microgrid controller of claim 2, wherein executing the load stabilization algorithm further comprises:
based on the second total allocated load being less than a charge power limit of the stabilizing group of energy resource systems:
setting the first total output power to a sum of the first total allocated load, the second total allocated load, and the charge power limit of the stabilizing group of energy resource systems, and
setting the second total output power to the charge power limit of the stabilizing group of energy resource systems.

5. The microgrid controller of claim 4, where the first total allocated load is a subtraction of the bias power from the first target load, and
wherein the second total allocated load is a sum of the second target load and the bias power.

6. The microgrid controller of claim 2, wherein the one or more processors are configured to receive a moving average window setpoint, calculate a moving average of the total load based on the total load and the moving average window setpoint, and calculate the first target load for the non-stabilizing group of energy resource systems based on the moving average of the total load.

7. The microgrid controller of claim 1, wherein the microgrid is configured, while the microgrid controller is executing the load stabilization algorithm, in a stand-alone state, during which the microgrid is disconnected from an external power distribution system.

8. The microgrid controller of claim 1, wherein the non-stabilizing group of energy resource systems includes one or more energy generator systems configured to generate power from respective power sources, and
wherein the stabilizing group of energy resource systems includes one or more energy storage systems having respective chargeable storage devices.

9. The microgrid controller of claim 1, wherein the plurality of loads includes at least one non-stable load.

10. The microgrid controller of claim 1, wherein the plurality of loads includes at least one cyclic load.

11. The microgrid controller of claim 1, wherein the one or more processors are configured to generate, based on the SOC of the stabilizing group of energy resource systems being less than a minimum threshold, the one or more second control signals to control at least one energy resource system of the non-stabilizing group of energy resource systems to provide the bias power to the stabilizing group of energy resource systems in order to increase the SOC of the stabilizing group of energy resource systems.

12. The microgrid controller of claim 1, wherein the one or more processors are configured to generate, based on the SOC of the stabilizing group of energy resource systems being greater than a maximum threshold, the one or more first control signals to control at least one energy resource system of the stabilizing group of energy resource systems to provide the bias power to a power distribution network of the microgrid in order to decrease the SOC of the stabilizing group of energy resource systems.

13. A microgrid controller of a microgrid, comprising:
one or more memories configured to store a load stabilization algorithm;
a communication interface configured to receive load information corresponding to a current load demand of a plurality of loads connected to the microgrid and output one or more control signals for controlling a plurality of energy resource systems associated with the microgrid, wherein the plurality of energy resource systems includes a non-stabilizing group of energy resource systems and a stabilizing group of energy resource systems; and
one or more processors, coupled to the one or more memories, configured to execute the load stabilization algorithm to generate the one or more control signals based on the load information, wherein executing the load stabilization algorithm comprises:
generating, based on the load information, one or more first control signals to dynamically control an amount of total output power provided by the stabilizing group of energy resource systems to a power distribution network of the microgrid in order to stabilize one or more cyclic loads on the power distribution network and to maintain the non-stabilizing group of energy resource systems at a substantially constant load.

14. The microgrid controller of claim 13, wherein executing the load stabilization algorithm further comprises:
generating, based on a total load of the plurality of loads, the one or more first control signals to control a first total output power provided by the stabilizing group of energy resource systems to the power distribution network of the microgrid, and
generating, based on the total load of the plurality of loads, one or more second control signals to control a second total output power provided by the non-stabilizing group of energy resource systems to the power distribution network of the microgrid.

15. The microgrid controller of claim 14, wherein executing the load stabilization algorithm further comprises:
monitoring a state-of-charge (SOC) of the stabilizing group of energy resource systems,
calculating a bias power to maintain the SOC of the stabilizing group of energy resource systems within a target range, and
calculating the first total output power and the second total output power based on the bias power.

16. The microgrid controller of claim 13, wherein executing the load stabilization algorithm further comprises:
calculating a total load of the plurality of loads based on the load information,
calculating a first target load for the non-stabilizing group of energy resource systems and a second target load for the stabilizing group of energy resource systems, wherein a sum of the first target load and the second target load is equal to the total load,
measuring a state-of-charge (SOC) of the stabilizing group of energy resource systems,
calculating a bias power to maintain the SOC of the stabilizing group of energy resource systems within a target range,
calculating a first total output power for the non-stabilizing group of energy resource systems based on the first target load and the bias power,
calculating a second total output power for the stabilizing group of energy resource systems based on the second target load and the bias power,
controlling, based on the first total output power, the non-stabilizing group of energy resource systems to produce the first total output power, and
controlling, based on the second total output power, the stabilizing group of energy resource systems to produce the second total output power.

17. The microgrid controller of claim 13, wherein the microgrid is configured, while the microgrid controller is executing the load stabilization algorithm, in a stand-alone state, during which the microgrid is disconnected from an external power distribution system.

18. The microgrid controller of claim 13, wherein the non-stabilizing group of energy resource systems includes one or more energy generator systems configured to generate power from respective power sources, and
wherein the stabilizing group of energy resource systems includes one or more energy storage systems having respective chargeable storage devices.

19. A control method, comprising:
receiving, by a microgrid controller of a microgrid, load information corresponding to a current load demand of a plurality of loads connected to the microgrid; and
controlling, by the microgrid controller, a plurality of energy resource systems associated with the microgrid, wherein the plurality of energy resource systems includes a non-stabilizing group of energy resource systems and a stabilizing group of energy resource systems,
wherein controlling the plurality of energy resource systems includes:
generating, based on the load information, one or more control signals to dynamically control an amount of total output power provided by the stabilizing group of energy resource systems to a power distribution network of the microgrid in order to stabilize one or more cyclic loads on the power distribution network and to maintain the non-stabilizing group of energy resource systems at a substantially constant load.

20. The control method of claim 19, further comprising:
monitoring, by the microgrid controller, a state-of-charge (SOC) of the stabilizing group of energy resource systems;
calculating, by the microgrid controller, a bias power to maintain the SOC of the stabilizing group of energy resource systems within a target range; and
calculating, by the microgrid controller, the amount of total output power based on the bias power.
